(19) United States
(12) Patent Application Publication
(10) Pub. No.: US 2025/0286305 A1
(43) Pub. Date: Sep. 11, 2025

(54) CABLE CONNECTOR ASSEMBLY HAVING CONNECTOR IDENTIFICATION MODULE

(71) Applicant: TE Connectivity Solutions GmbH, Schaffhausen (CH)

(72) Inventors: Joshua Tyler Sechrist, Fremont, CA (US); Albert Tsang, Middletown, PA (US)

(21) Appl. No.: 18/970,606

(22) Filed: Dec. 5, 2024

Related U.S. Application Data
(60) Provisional application No. 63/563,670, filed on Mar. 11, 2024.

(51) Int. Cl. H01R 13/46; H01R 12/72; H01R 13/502; H01R 13/631; H01R 13/74

(52) U.S. Cl. CPC H01R 13/465; H01R 12/721; H01R 13/502; H01R 13/6315; H01R 13/748

(57) ABSTRACT

A connector assembly for mating with a mating connector assembly includes a connector holder that has a frame defining a connector chamber configured to be mounted to a panel. The connector assembly includes a cable connector received in the connector chamber and extending forward from the front of the frame to pass through an opening in the panel for mating with the mating connector. The connector assembly includes a connector identification module held by the frame including a mating end configured to be mated with a mating identification module of the mating connector assembly. The connector identification module includes an identification device having unique identification data and operably coupled to the identification contacts to transmit the unique identification data to the mating identification module.

### CROSS REFERENCE TO RELATED APPLICATIONS

This application claims benefit to U.S. Provisional Application No. 63/563,670, filed 11 Mar. 2024, titled “CABLE CONNECTOR ASSEMBLY HAVING CONNECTOR IDENTIFICATION MODULE”, the subject matter of which is herein incorporated by reference in its entirety.

### BACKGROUND OF THE INVENTION

The subject matter herein relates generally to communication systems.

Cable assemblies are used to electrically connect various components within a system, such as a server or network system. The cable assemblies extend between the components, such as network, compute, storage, memory, or other components. The components may be arranged in shelves or trays of a network rack. Some systems may include components such as cards, such as line cards, daughter cards, mother boards, and the like. Each cable assembly includes multiple cables arranged in a bundle or array. Each cable forms a data channel. As the density of cable assemblies in the network system increase, it is desirable to know the locations of the components within the system, the manufacturing information of components and other device readable information, such as for service, repair or replacement.

A need remains for a method and device for identifying components and locations of components within a network system.

### BRIEF DESCRIPTION OF THE INVENTION

In one embodiment, a connector assembly for mating with a mating connector assembly is provided. The connector assembly includes a connector holder that has a frame defining a connector chamber. The frame extends between a front and a rear of the connector holder. The frame includes an upper frame member, a lower frame member, and first and second side frame members extend between the upper and lower frame members to define the connector chamber. The connector holder configured to be mounted to a panel. The connector assembly includes a cable connector received in the connector chamber. The cable connector includes a connector housing holding contact assemblies. Each contact assembly includes a signal contact and a cable terminated to the signal contact. The signal contact configured to be mated with a mating signal contact of a mating connector of the mating connector assembly. The cable connector has a mating end that extends forward from the front of the frame and configured to pass through an opening in the panel for mating with the mating connector in a mating direction. The connector assembly includes a connector identification module is held by the frame and includes a mating end configured to be mated with a mating identification module of the mating connector assembly. The connector identification module includes identification contacts and an identification device. The identification contacts arranged at the mating end and configured to be mated with the mating identification module. The identification device has unique identification data stored on the identification device. The identification device is operably coupled to the identification contacts to transmit the unique identification data to the mating identification module.

In another embodiment, a connector assembly for mating with a mating connector assembly is provided. The connector assembly includes a connector holder that has a frame defining a connector chamber. The frame extends between a front and a rear of the connector holder. The frame includes an upper frame member, a lower frame member, and first and second side frame members extend between the upper and lower frame members to define the connector chamber. The connector holder configured to be mounted to a panel. The connector assembly includes a cable connector received in the connector chamber. The cable connector includes a connector housing holding contact assemblies. Each contact assembly includes a signal contact and a cable terminated to the signal contact. The signal contact configured to be mated with a mating signal contact of a mating connector of the mating connector assembly. The cable connector has a mating end that extends forward from the front of the frame and configured to pass through an opening in the panel for mating with the mating connector in a mating direction. The connector assembly includes a connector identification module held by the frame and includes a mating end configured to be mated with a mating identification module of the mating connector assembly. The connector identification module includes a printed circuit board that has a card edge at the mating end. The connector identification module includes identification contacts arranged at the card edge. The connector identification module includes an identification device mounted to the printed circuit board. The identification device has unique identification data stored on the identification device. The identification device is operably coupled to the identification contacts, wherein the card edge is configured to be plugged into a card slot of the mating identification module when the connector assembly is mated with the mating connector assembly to transmit the unique identification data to the mating identification module.

In a further embodiment, a communication system is provided and includes a cartridge that has panels forming a chamber. The panels include a front panel. The cartridge includes ports in the front panel at a front of the cartridge. The communication system includes connector assemblies received in the ports for mating with mating connector assemblies. Each connector assembly includes a connector holder, a cable connector held by the connector holder, and a connector identification module for identifying the cable connector within the communication system. Each connector holder has a frame defining a connector chamber. The frame extends between a front and a rear of the connector holder. The frame includes an upper frame member, a lower frame member, and first and second side frame members extend between the upper and lower frame members to define the connector chamber. The connector holder is mounted to the cartridge at the corresponding port. Each cable connector is received in the corresponding connector chamber. Each cable connector includes a connector housing holding contact assemblies. Each contact assembly includes a signal contact and a cable terminated to the signal contact. The cable extends from the cable connector into the chamber of the cartridge. The signal contact configured to be mated with a mating signal contact of a mating connector of the corresponding mating connector assembly. The cable connector has a mating end that extends forward from the front of the frame and is configured to pass through the corresponding port in the front panel for mating with the mating connector in a mating direction. Each connector identification module is held by the frame proximate to the cable connector. The connector identification module includes a mating end configured to be mated with a mating identification module of the corresponding mating connector assembly. The connector identification module includes identification contacts and an identification device. The identification contacts arranged at the mating end and configured to be mated with the mating identification module. The identification device has unique identification data stored on the identification device. The identification device is operably coupled to the identification contacts to transmit the unique identification data to the mating identification module.

### BRIEF DESCRIPTION OF THE DRAWINGS

FIG. 1 is a front view of a communication system in accordance with an exemplary embodiment.

FIG. 2 is a front view of a portion of the communication system in accordance with an exemplary embodiment.

FIG. 3 illustrates a portion of the communication system showing two of the cartridges in accordance with an exemplary embodiment.

FIG. 4 is a perspective view of a portion of the communication system showing one of the mating connector assemblies poised for coupling to the corresponding connector assembly in accordance with an exemplary embodiment.

FIG. 5 is a front perspective view of a portion of the communication system showing one of the connector assemblies in accordance with an exemplary embodiment coupled to the front panel of the cartridge.

FIG. 6 is a front perspective, exploded view of the connector assembly in accordance with an exemplary embodiment.

FIG. 7 is a front perspective view of one of the contact modules in accordance with an exemplary embodiment.

FIG. 8 is an enlarged view of the mating end of the contact module in accordance with an exemplary embodiment.

FIG. 9 is a cross sectional view of a portion of the communication system showing the mating connector assembly mated with the connector assembly showing the connector identification module in accordance with an exemplary embodiment.

FIG. 10 is a cross sectional view of a portion of the communication system showing the mating connector assembly mated with the connector assembly showing the connector identification module in accordance with an exemplary embodiment.

FIG. 11 is a perspective view of the connector identification module in accordance with an exemplary embodiment.

FIG. 12 is a top view of a portion of the communication system in accordance with an exemplary embodiment showing the mating connector assembly mated with the connector assembly showing the connector identification module shown in FIG. 11.

FIG. 13 is a side view of a portion of the communication system in accordance with an exemplary embodiment showing the mating connector assembly mated with the connector assembly showing the connector identification module shown in FIG. 11.

FIG. 14 is a rear perspective view of a portion of the communication system in accordance with an exemplary embodiment showing the mating connector assembly mated with the connector assembly showing the connector identification module shown in FIG. 11.

### DETAILED DESCRIPTION OF THE INVENTION

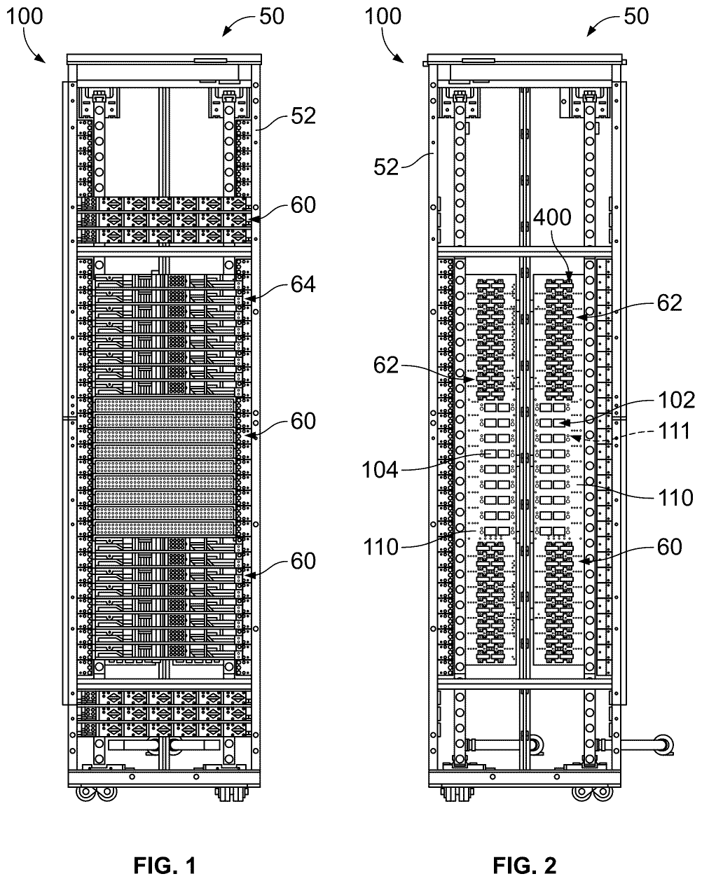

FIG. 1 is a front view of a communication system 100 in accordance with an exemplary embodiment. FIG. 2 is a front view of a portion of the communication system 100 in accordance with an exemplary embodiment. In an exemplary embodiment, the communication system 100 includes a chassis or rack 50 having a rack frame 52 holding electrical components 60. The rack 50 may be a server rack. The electrical components 60 may include fixed modules 62 (FIG. 2) and/or removable modules 64 (FIG. 1). The removable modules 64 may be mated to the fixed modules 62. For example, the removable modules 64 may be plugged into the rack frame 52 and removable from the rack frame 52. In various embodiments, the electrical components 60 may include one or more patch panels, switches, servers, routers, firewalls, and the like. The rack frame 52 may hold a power supply, cooling components, and the like.

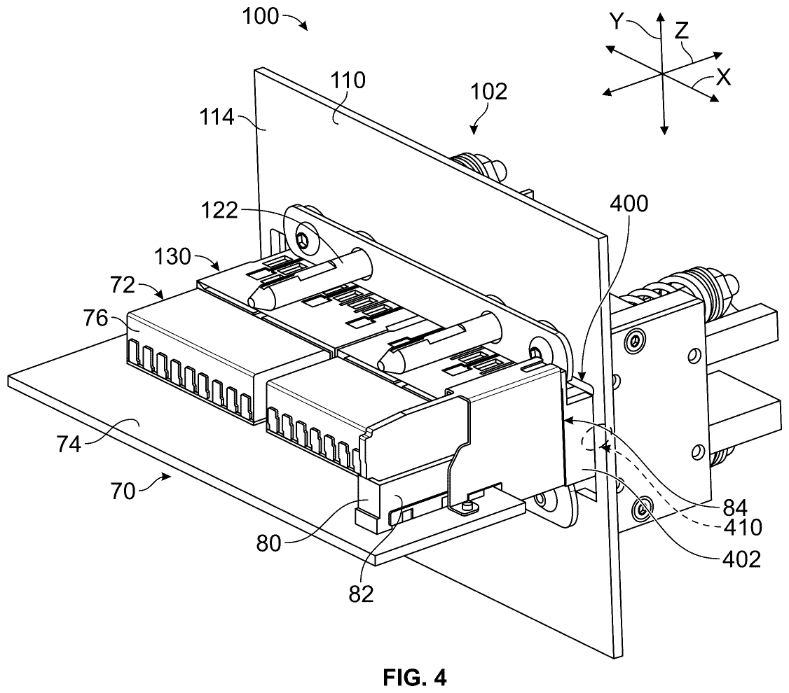

In an exemplary embodiment, the communication system 100 includes at least one connector assembly 102 (FIG. 2) and at least one mating connector assembly 70 (FIG. 4) configured to be mated with the corresponding at least one connector assembly 102. The connector assembly 102 may be part of one of the electrical components 60, such as one of the fixed modules 62. The mating connector assembly 70 may be part of one of the electrical components 60, such as one of the removable modules 64. In various embodiments, each mating connector assembly 70 may include one or more mating electrical connectors mounted to a circuit board, such as a backplane, a daughter card, a network switch, and the like.

In an exemplary embodiment, the communication system 100 includes a connector identification system 400 to identify the various connector assemblies 102 and/or mating connector assemblies 70. The connector identification system 400 may be used to identify physical locations of the connector assemblies 102 within the communication system 100, such as to identify which connector in a cable harness is electrically connected to which electrical component 60 for system management. In an exemplary embodiment, the connector identification system 400 may use identification devices, such as EEPROMs (Electrically Erasable and Programmable Read Only Memory), to hold information that allows identification of the various connector assemblies 102. The identification devices may be incorporated with each of the connector assemblies 102. For example, the identification devices may be incorporated into the connector assembly 102, such as housed within the connector assembly and having a mating interface configured to mate with the mating connector assembly 70. The identification devices may have unique identification information programmed into the identification devices, such as a part number, a program name, a slot ID number, data about the associated connector assembly 102, and the like. In an exemplary embodiment, the identification devices also include supporting componentry like Resistors, Capacitors, and other supporting Integrated Circuits. In an exemplary embodiment, the identification devices are modular and may be incorporated into different types of connector assemblies 102.

In an exemplary embodiment, the communication system 100 includes a cabinet or cartridge 110 that holds the connector assemblies 102. The connector assemblies 102 may be cable connector assemblies having cables extending from corresponding cable connectors. The cartridge 110 may form part of the fixed modules 62. Optionally, multiple cartridges 110 may be provided (for example, left side and right side). The cartridge 110 may be coupled to the rack frame 52, such as at the rear of the rack frame 52. The cartridge 110 forms an enclosed space or chamber 111 for the connector assemblies 102 and the cables of the connector assemblies 102. The cartridge 110 is used for cable management. For example, the cables may be part of cable harnesses routed within the enclosed chamber 111 formed by the cartridge 110 electrically connecting the various connector assemblies 102. The cartridge 110 is used to support or position the connector assemblies 102 for mating with the mating connector assemblies 70.

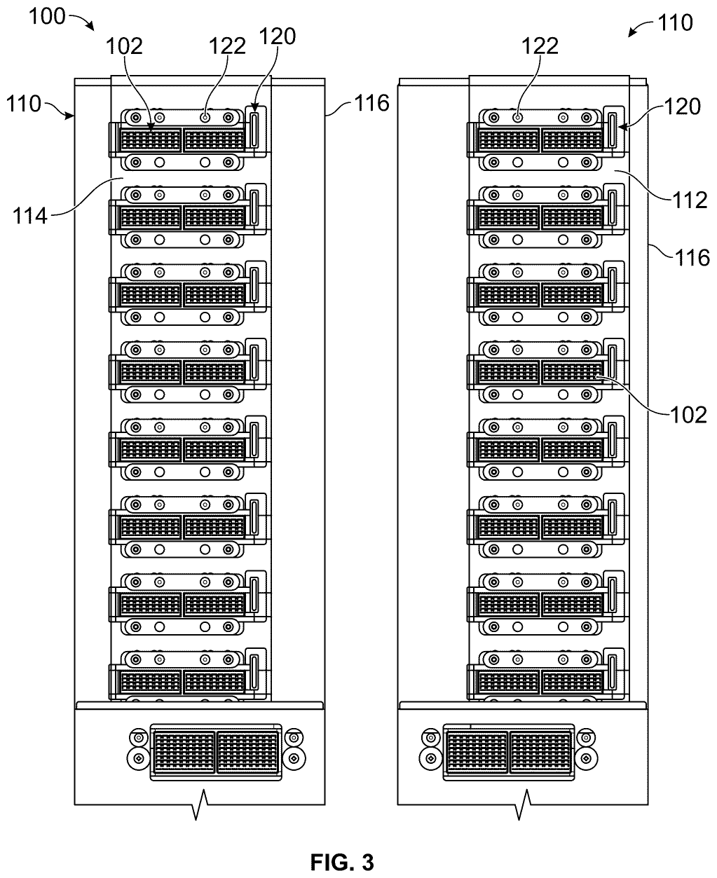

FIG. 3 illustrates a portion of the communication system 100 showing two of the cartridges 110 in accordance with an exemplary embodiment. Each cartridge 110 holds a plurality of the connector assemblies 102, such as in one or more rows and one or more columns. The connector assemblies 102 are provided at the front of the cartridge 110 for interfacing with the mating connector assemblies 70 (shown in FIG. 4).

In an exemplary embodiment, the cartridge 110 is formed from a plurality of panels 112, such as sheet metal panels. The cartridge 110 includes a front panel 114, side panels 116, and a rear panel 118. The panels 112 may additionally include an upper panel and/or a lower panel. The connector assemblies 102 are provided at the front panel 114 for mating with the mating connector assemblies 70. In an exemplary embodiment, the connector assemblies 102 are arranged in a column along the front panel 114. Optionally, the connector assemblies 102 may be provided in multiple columns. The mating ends of the connector assemblies 102 are external to the cartridge 110. For example, the connector assemblies 102 pass through ports or openings 120 in the front panel 114. The connector assemblies 102 are coupled to the front panel 114 adjacent the openings 120. In an exemplary embodiment, the connector assemblies 102 may float or move relative to the front panel 114 to align with and mate to the mating connector assemblies 70. In an exemplary embodiment, the connector assemblies 102 include mating guides, such as guide posts 122, to guide mating of the mating electrical connectors 72 with the connector assemblies 102. The guide posts 122 extend forward of the front panel 114.

FIG. 4 is a perspective view of a portion of the communication system 100 showing one of the mating connector assemblies 70 coupled to the corresponding connector assembly 102. The connector assembly 102 is coupled to the cartridge 110, such as to the front panel 114. In the illustrated embodiment, the mating connector assembly 70 is a network component. For example, the mating connector assembly 70 may be a compute node, a memory module, a network switch, a storage device, a network accelerator, or another type of communication component. The mating connector assembly 70 may be a backplane component or a daughtercard component.

In an exemplary embodiment, the connector assembly 102 includes a connector identification module 402, forming part of the connector identification system 400. The connector identification module 402 is associated with the cable connector(s) of the connector assembly 102. The connector identification module 402 is used to identify the connector assembly 102 within the communication system 100. The connector identification module 402 is integrated with the other components of the connector assembly 102 for mating with the corresponding mating connector assembly 70.

In an exemplary embodiment, the connector identification module 402 includes an identification device 410 holding unique identification data. The identification device 410 is able to uniquely identify the connector assembly 102. For example, the identification device 410 is able to identify the cable connector from a plurality of cable connectors, such as within the cartridge 110. The identification device 410 may identify the location of the connector assembly 102 or other identifying information about the cable connector(s) or other components of the connector assembly 102. In an exemplary embodiment, the identification device 410 is an EEPROM device that is programmable and configured to store unique identification data.

In an exemplary embodiment, the mating connector assembly 70 includes a mating electrical connector 72 mounted to a circuit board 74. The mating connector assembly 70 may be mounted to a front edge of the circuit board 74. The mating electrical connector 72 includes a connector housing 76 holding signal contacts (not shown) and ground shields shielding the signal contacts. The signal contacts may be arranged in pairs. The signal contacts may be spring beams in various embodiments. The signal contacts may be pins, sockets, or other types of contacts in alternative embodiments. The signal contacts are terminated to the circuit board 74.

In an exemplary embodiment, the mating connector assembly 70 includes a mating identification module 80 mounted to the circuit board 74. The mating identification module 80 is configured to be mated with the connector identification module 402 of the connector assembly 102. The unique identifying data is configured to be transmitted from the connector identification module 402 to the mating identification module 80 when the mating connector assembly 70 is mated with the connector assembly 102. In an exemplary embodiment, the mating identification module 80 includes an identification connector, such as a card edge connector 82, mounted to the circuit board 74.

The card edge connector 82 includes a card slot 84 configured to receive a portion of the connector identification module 80. In the illustrated embodiment, the card slot 84 is oriented vertically. In an exemplary embodiment, the connector identification module 402 is an orthogonal connector. For example, the mating interface of the connector identification module 402 is oriented perpendicular to the circuit board 74. The mating identification module 80 may include additional components, such as a microprocessor, an EEPROM chip, or other type of component, mounted to the circuit board 74 operably coupled to the card edge connector 82 for controlling communication between the connector assembly 102 and the mating connector assembly 70. The mating identification module 80 may include a communication module, such as a wireless communication device, such as a transmitter or other type of wireless communication device, to transmit the data from the connector identification module 402 to a remote device, such as a central processing unit for the communication system 100.

The connector assembly 102 is received in the cartridge 110. The connector assembly 102 is provided at the front panel 114 for mating with the mating connector assembly 70 along a mating axis. In the illustrated embodiment, the mating axis extends along the Z-axis. The mating end of the cable connector 130 is configured to pass through an opening or port in the front panel 114 for mating with the mating electrical connector 72. A mating end of the connector identification module 402 may pass through an opening in the front panel 114 for mating with the mating identification module 80. The connector assemblies 102, 70 are configured to transmit and/or receive data through an interface. In an exemplary embodiment, the identification devices of the connector identification system 400 are integrated with the connector assemblies 102 to mate with the mating connector assemblies 70. For example, the connector identification module 402 may directly mate with the mating identification module 80 when the mating connector assembly 70 is mated to the connector assembly 102. The connector assemblies 102 may include receptacle connectors and the mating connector assemblies 70 may include plug connectors. In an exemplary embodiment, the guide post 122 is configured to be mated with a guide module (not shown) of the mating connector assembly 70 to guide mating of the mating connector assembly 70 with the connector assembly 102. The guide module may be mounted to the circuit board 74 and/or the mating electrical connector 72. The guide post 122 and the guide module may guide mating of the connector identification module 402 and the mating identification module 80. In an exemplary embodiment, the guide module includes an opening that receives the guide post 122. The mating guides may be used to align the connectors in one or more lateral directions transverse to the mating axis, such as along the X-axis and/or the Y-axis. In various embodiments, the mating guides may provide both horizontal alignment (X-axis) and vertical alignment (Y-axis).

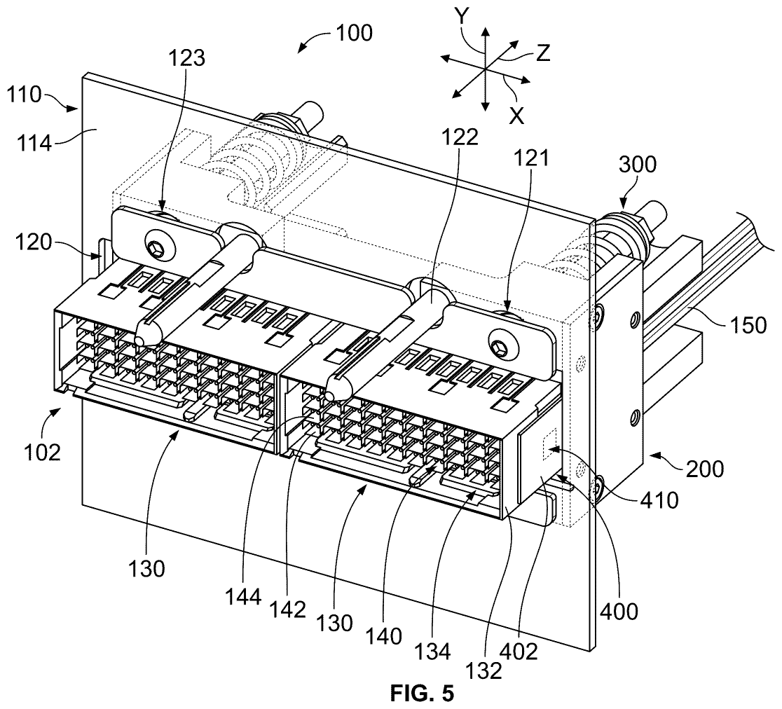

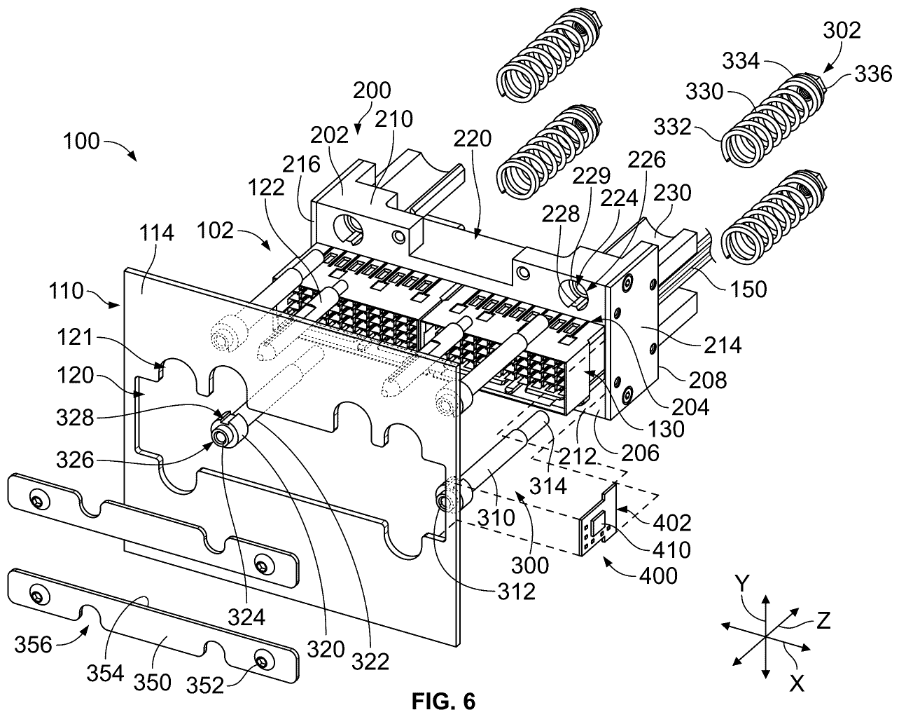

FIG. 5 is a front perspective view of a portion of the communication system 100 showing one of the connector assemblies 102 in accordance with an exemplary embodiment coupled to the front panel 114 of the cartridge 110. FIG. 6 is a front perspective, exploded view of the connector assembly 102 in accordance with an exemplary embodiment. The connector assembly 102 includes one or more cable connectors 130, a connector holder 200 holding the cable connector(s) 130, a mounting assembly 300 for mounting the connector holder 200 and the cable connector(s) 130 to the front panel 114 of the cartridge 110, and a connector identification module 402 associated with the cable connector(s) 130. The connector identification module 402 is part of the connector identification system 400 used to identify the connector assembly 102 within the system. The connector identification module 402 is integrated with the cable connector 130 in the connector holder 200. The connector identification module 402 is configured to be mated to the mating connector assembly 70 with the cable connector 130.

In an exemplary embodiment, the connector identification module 402 includes an identification device 410 holding unique identification data. The identification device 410 is able to uniquely identify the cable connector 130. For example, the identification device 410 is able to identify the cable connector 130 from a plurality of cable connectors, such as within the cartridge 110. The identification device 410 may identify the location of the cable connector 130 or other identifying information about the cable connector 130. In an exemplary embodiment, the identification device 410 is an EEPROM device that is programmable and configured to store unique identification data.

In the illustrated embodiment, the connector assembly 102 includes two cable connectors 130 arranged side-by-side. However, greater or fewer cable connectors 130 may be provided in alternative embodiments. The cable connectors 130 may be vertically stacked rather than horizontally stacked in alternative embodiments. The mating ends of the cable connectors 130 pass through the opening 120 in the front panel 114 for mating with the mating electrical connector 72 (FIG. 4).

The cable connector 130 includes a connector housing 132 holding a plurality of communication contact modules 160 configured to transmit data, such as high speed data signals. The contact modules 160 include contact assemblies 140 configured to be mated with the mating connector assembly 104. The contact assemblies 140 are terminated to ends of cables 150 extending from the cable connector 130. For example, the cables 150 may extend from the rear ends of the contact modules 160. The contact assemblies 140 are arranged together within the contact modules 160. For example, the contact modules 160 hold the contact assemblies 140 in columns. A plurality of the contact modules 160 are received in the connector housing 132, such as being arranged in a contact module stack.

The connector housing 132 includes a cavity 134 that receives the contact modules 160. The contact assemblies 140 are arranged in the cavity 134 at a mating end for mating with the mating electrical connector 106. For example, the contact assemblies 140 are arranged in the cavity 134 in rows and columns. The cavity 134 may form a receptacle that receives the mating end of the mating electrical connector 106. The walls of the connector housing 132 may be chamfered and have a lead-in surfaces to guide mating of the mating electrical connector 72 in the cavity 134. The connector housing 132 may have guide features to properly position the mating electrical connector 72 within the cavity 134. In an exemplary embodiment, the connector housing 132 includes a plurality of module slots 136 in the cavity 134. Each module slot 136 receives one of the contact modules 160. The contact modules 160 may be latchably coupled to the connector housing 132 in the corresponding module slots 136.

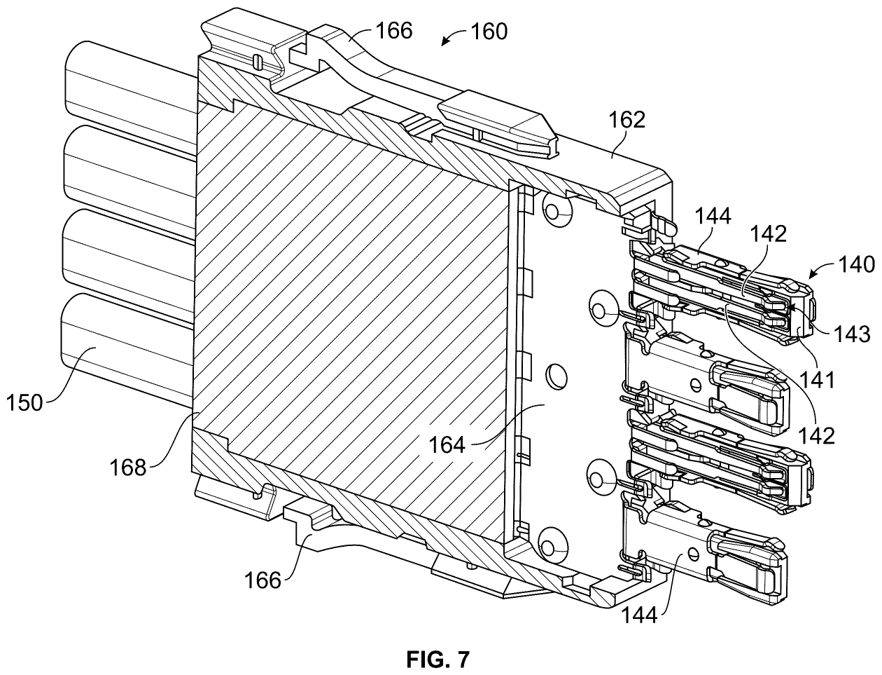

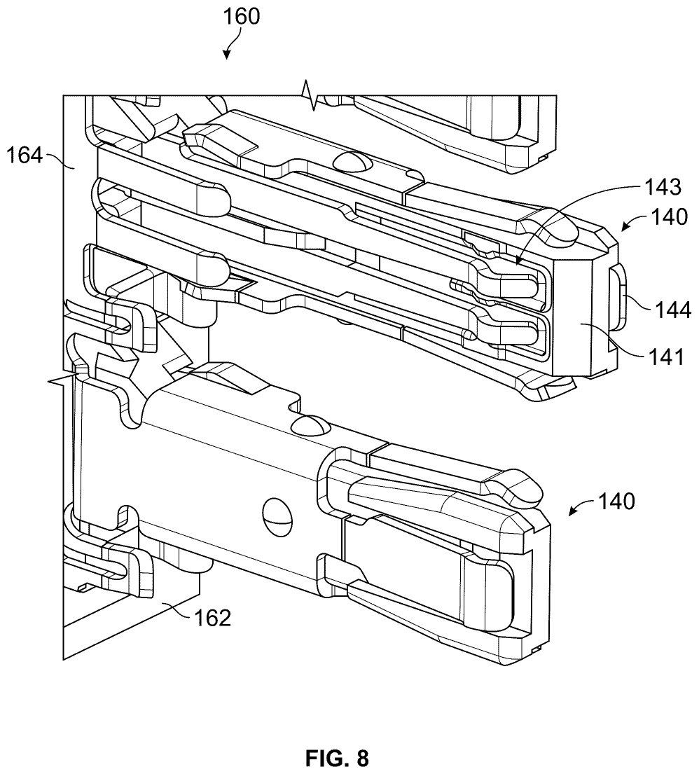

With additional reference to FIG. 7, which is a front perspective view of one of the contact modules 160 in accordance with an exemplary embodiment, and FIG. 8, which is an enlarged view of the mating end of the contact module 160, the contact module 160 includes a structure holding the contact assemblies 140 and the cables 150. For example, the contact module 160 includes a body 162 holding the contact assemblies 140 and the cables 150. The cables 150 extend from a cable end of the contact module 160. The contact assemblies 140 extend from a mating end of the contact module 160.

The body 162 may be generally rectangular having atop, a bottom, a front, a rear, a first side and a second side. The sides may be generally planar and parallel to each other configured to be stacked in the module stack side-by-side with the other contact modules 160. In an exemplary embodiment, the body 162 holds a ground shield 164. The body 162 includes latches 166, such as at the top and the bottom of the body 162, used to secure the contact module 160 in the connector housing 132 (FIG. 5). The contact module 160 may include a strain relief 168, such as at the cable end, configured to hold the ends of the cables 150 and provide strain relief for the cables 150. The strain relief 168 may be an overmold overmolded over the ends of the cables 150.

Each contact assembly 140 includes at least one signal contact 142, a contact holder 141 holding the at least one signal contact 142, and a shield 144 coupled to the contact holder 141 and providing electrical shielding for the at least one signal contact 142. Optionally, multiple contact assemblies 140 may be integrated into a common structure. For example, the contact holders 141 of each of the contact assemblies 140 may be a unitary structure, such as being a single molded piece holding all of the signal contacts 142 and the shields 144.

In the illustrated embodiment, each contact assembly 140 includes a pair of the signal contacts 142, which define a differential pair. In various embodiments, the signal contacts 142 may be deflectable spring beams. However, in alternative embodiments, the signal contacts 142 may be pin contacts, socket contacts, or other types of contacts. The signal contacts 142 may be stamped and formed contacts. Each signal contact 142 is configured to be electrically connected to a corresponding wire or conductor of the cable 150. In an exemplary embodiment, the cable 150 is a twin-axial cable having a first conductor and a second conductor terminated to corresponding signal contacts 142.

The contact holder 141 is manufactured from a dielectric material, such as a plastic material. The contact holder 141 may be a molded part. The contact holder 141 includes a contact channel 143 for each signal contact 142. In the illustrated embodiment, the contact holder 141 has two contact channels 143 for the pair of signal contacts 142. In various embodiments, the contact holder 141 is preformed and the signal contacts 142 are loaded into the contact holder 141. In other various embodiments, the contact holder 141 is formed in situ around the signal contacts 142, such as being overmolded over the signal contacts 142. The cable 150 may extend into an end of the contact holder 141 to terminate to the signal contacts 142. The contact holder 141 may provide strain relief for the end of the cable 150. In other embodiments, a single contact holder may be provided for the contact module 160 configured to hold each of the pairs of the signal contacts 142, such as four pairs of the signal contacts 142 in a single molded part.

The shield 144 may be a stamped and formed shield. The shield 144 is configured to be coupled to the contact holder 141. Optionally, shields may be provided at both sides of the contact module 160. The shield 144 may provide shielding on multiple sides of the signal contacts 142. In an exemplary embodiment, the front end of the shield 144 is C-shaped providing electrical shielding on three sides of the pair of signal contacts 142. The shield 144 may have other shapes in alternative embodiments. The shield 144 may have deflectable spring beams configured to be mated to a shield structure of the mating connector assembly 104. The shield 144 may be configured to be electrically connected to the cable shield of the cable.

With reference back to FIGS. 5 and 6, the connector holder 200 is used to hold the cable connector(s) 130 and the connector identification module 402 relative to the front panel 114. The connector holder 200 is configured to be coupled to the cartridge 110, via the mounting assembly 300, to position each cable connector 130 and the connector identification module 402 relative to the cartridge 110. In an exemplary embodiment, the cable connector 130 is movable relative to the connector holder 200 to position the cable connector 130 during mating with the mating electrical connector 72 (FIG. 4). For example, the connector holder 200, and thus the cable connector 130 and the connector identification module 402, may be movable along the mating axis (along the Z-axis) to accommodate overtravel of the mating connector assembly 70 during mating. In various embodiments, the connector holder 200, and thus the cable connector 130 and the connector identification module 402, may have a limited amount of floating movement relative to the front panel 114 to accommodate misalignment of the cable connector 130 relative to the mating electrical connector 72. For example, the mounting assembly 300 allows movement of the connector holder 200 relative to the front panel 114 along the X-axis and/or along the Y-axis to accommodate misalignment of the cable connector 130 relative to the mating electrical connector 72. The mounting assembly 300 may limit or confine the amount of floating movement in the lateral floating directions X/Y. For example, the mounting assembly 300 may limit floating movement, such as to approximately 5.0 mm for mating tolerance. In various embodiments, the mounting assembly 300 may limit floating movement to approximately 3.0 mm for mating tolerance.

The connector holder 200 includes a frame 202 defining a connector chamber 204. The cable connector(s) 130 are received in the connector chamber 204. The frame 202 supports the cable connector 130 in the connector chamber 204. The connector identification module 402 may be coupled to the frame 202. In various embodiments, the connector identification module 402 is mounted directly to the frame 202. The connector identification module 402 may be located in the connector chamber 204. In other various embodiments, the connector identification module 402 may be mounted to an exterior of the frame 202, such as to a side of the frame 202. The connector identification module 402 may be coupled to the frame 202 in alignment with the cable connectors 130, such as in line with (for example, coplanar) the cable connectors 130. The connector identification module 402 may be arranged side-by-side with the cable connector 130.

The frame 202 extends between a front 206 and a rear 208 of the connector holder 200. The mating ends of each cable connector 130 is provided at or forward of the front 206 of the connector holder 200 for mating with the mating electrical connector 72. The mating end of the connector identification module 402 is provided at or forward of the front 206 of the connector holder 200 for mating with the mating identification module 80. The cables 150 extends from the rear 208 of the connector holder 200. The guide posts 122 extend forward from the front 206, such as above the cable connector 130. Other locations are possible in alternative embodiments, such as the bottom for one or both sides of the frame 202.

In an exemplary embodiment, the frame 202 includes an upper frame member 210, a lower frame member 212, a first side frame member 214, and a second side frame member 216. The connector chamber 204 is defined between the upper frame member 210 and the lower frame member 212. The connector chamber 204 is defined between the first and second side frame members 214, 216. In an exemplary embodiment, the connector identification module 402 is supported by one of the frame members, such as the first side frame member 214. For example, the connector identification module 402 may be directly coupled to the first side frame member 214, such as to the interior surface or the exterior surface of the first side frame member 214.

The upper frame member 210, the lower frame member 212, the first side frame member 214, and/or the second side frame member 216 may be plates or blocks. For example, the upper frame member 210, the lower frame member 212, the first side frame member 214, and/or the second side frame member 216 may be stamped and formed plates. The upper frame member 210, the lower frame member 212, the first side frame member 214, and/or the second side frame member 216 may be die cast or molded blocks. In an exemplary embodiment, the upper frame member 210, the lower frame member 212, the first side frame member 214, and/or the second side frame member 216 may be discrete pieces secured together using fasteners, clips, latches, welding or other securing means. In other various embodiments, the upper frame member 210, the lower frame member 212, the first side frame member 214, and/or the second side frame member 216 may be integral with each other. The upper frame member 210, the lower frame member 212, the first side frame member 214, and the second side frame member 216 form a brick 220 used to hold the cable connectors 130 and the connector identification module 402. The brick 220 is a rectangular structure that surrounds the connector chamber 204. The brick 220 is configured to be coupled to the cartridge 110 to hold the cable connectors 130 and the connector identification module 402 relative to the cartridge 110.

In an exemplary embodiment, the frame 202 includes mounting features 224 configured to be coupled to the mounting assembly 300. In the illustrated embodiment, the mounting features 224 include openings 226 in the frame members, such as in the upper frame member 210 and/or the lower frame member 212. In the illustrated embodiment, four openings 226 are provided near the four corners of the brick 220. In an exemplary embodiment, the mounting features 224 include keying features 228 for keyed mating with the mounting assembly 300. For example, the keying features 228 may be ribs, tabs or other types of protrusions extending into the openings 226. In other embodiments, the keying features 228 may be grooves, slots or other types of openings.

In an exemplary embodiment, the mounting assembly 300 is operably coupled between the connector holder 200 and the front panel 114. The mounting assembly 300 allows the connector holder 200, and thus the cable connector(s) 130 and the connector identification module 402 to move relative to the front panel 114. For example, the mounting assembly 300 allows the connector holder 200 to move along the mating axis (Z-direction), such as to accommodate overtravel of the mating connector assembly 70 during mating. The mounting assembly 300 allows the connector holder 200, and thus the cable connector 130 and the connector identification module 402, to move in one or more lateral floating directions perpendicular to the mating direction, such as in a horizontal floating direction (X-axis) and/or a vertical floating direction (Y-axis).

In an exemplary embodiment, the mounting assembly 300 includes one or more locating assemblies 302 configured to interface with the connector holder 200 at the corresponding mounting features 224. Each locating assembly 302 of the mounting assembly 300 includes a shaft 310, a biasing member 330 operably coupled between the connector holder 200 and the shaft 310, and a support element 350 configured to be operably coupled between the shaft 310 and the front panel 114 of the cartridge 110 to support the shaft 310 relative to the front panel 114.

The support element 350 may be a front support configured to be coupled to the front panel 114 of the cartridge 110. The support element 350 is coupled to the shaft(s) 310, such as using fasteners 352, clips, latches, welding, or other securing means. In an exemplary embodiment, the support element 350 includes an inner surface 354 configured to be coupled to the front surface of the panel 114. In an exemplary embodiment, the support element 350 includes an elongated plate, such as extending along the top and/or bottom and/or sides of the opening 120. The support element 350 may be planar. The support element 350 may be coupled to multiple shafts 310. The support element 350 may include notches 356 that receive the guide posts 122. The support element 350 may have other shapes in alternative embodiments. For example, the support element 350 may be circular and configured to mate to a single shaft 310.

The shaft 310 is configured to be coupled to the support element 350. For example, the shaft 310 is configured to extend through a corresponding locating opening 121 in the front panel 114 to interface with the support element 350. The front panel 114 may be captured between the support element 350 and the shaft 310. The locating opening 121 may be at or near the port 120 in the front panel 114, such as being open to the port 120. In an exemplary embodiment, the shaft 310 is undersized relative to the locating opening 121 to allow a limited amount of floating movement in the locating opening 121 in a float direction (X-direction and/or Y-direction) perpendicular to the mating direction (Z direction) to allow the connector holder 200 and the cable connector 130 to move relative to the panel 114. In an exemplary embodiment, the biasing member 330 forward biases the connector holder 200 and the cable connector 130, such as to press the connector holder 200 toward the rear side of the panel 114. The biasing member 330 is compressible in a rearward compression direction parallel to the mating direction (for example, along the Z axis) to allow the connector holder 200 and the cable connector 130 to move rearward relative to the panel 114. As such, the mounting assembly 300 allows floating movement of the connector holder 200, and thus the cable connector(s) 130, in X/Y/Z directions to align the cable connectors 130 with the mating connectors 72 (FIG. 4) during the mating process.

In an exemplary embodiment, the locating openings 121 are used to control floating movement of the connector assembly 102, such as in the lateral floating direction(s) (for example, X direction and/or Y direction). In an exemplary embodiment, each locating opening 121 is oversized relative to the shaft 310. For example, clearance gaps may be provided around the shaft 310 to move or float laterally within the locating opening 121. In an exemplary embodiment, the locating opening 121 is horizontally oversized relative to the shaft 310 allowing the shaft 310 to move side-to-side within the locating opening 121 to allow a limited amount of lateral floating movement of the connector holder 200, and thus the cable connector(s) 130 and the connector identification module 402, relative to the front panel 114. As such, the connector housing 132 is movable in the X-direction (for example, side-to-side) relative to the panel 114. The amount of lateral movement may be limited to a confined amount by the edges of the panel defining the locating opening 121. In an exemplary embodiment, the locating opening 121 is vertically oversized relative to the shaft 310 allowing the shaft 310 to move up-and-down within the locating opening 121 to allow a limited amount of lateral floating movement of the connector holder 200, and thus the cable connector(s) 130 and the connector identification module 402, relative to the front panel 114. As such, the connector housing 132 is movable in the Y-direction (for example, up and down) relative to the panel 114. The amount of lateral movement may be limited to a confined amount by the edges of the panel 114 defining the locating opening 121.

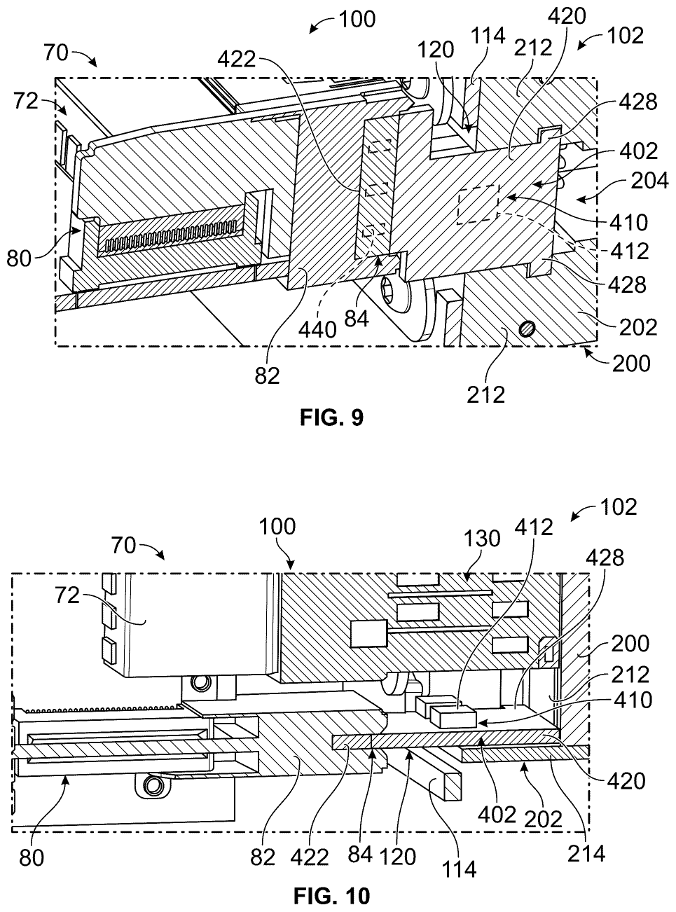

FIG. 9 is a cross sectional view of a portion of the communication system 100 showing the mating connector assembly 70 mated with the connector assembly 102 showing the connector identification module 402 in accordance with an exemplary embodiment. FIG. 10 is a cross sectional view of a portion of the communication system 100 showing the mating connector assembly 70 mated with the connector assembly 102 showing the connector identification module 402 in accordance with an exemplary embodiment.

The cable connector 130 and the connector identification module 402 extend from the front of the connector holder 200 for mating with the mating connector assembly 70. For example, the cable connector 130 and the connector identification module 402 extend through the opening 120 in the front panel 114 for direct mating with the mating connector 72 and the mating identification connector 82.

In an exemplary embodiment, the connector identification module 402 includes the identification device 410 and identification contacts 440 operably coupled to the identification device 410. The identification contacts 440 may be signal contacts, power contacts, ground contacts, or other types of contacts. The identification contacts 440 are configured to be mated with the mating identification connector 82 to electrically connect the connector identification module 402 and the mating identification module 80.

In an exemplary embodiment, the identification device 410 includes an electronic device 412 that stores unique identification data. The electronic device 412 may be an integrated circuit, such as a chip. In an exemplary embodiment, the electronic device 412 is an EEPROM device, such as an EEPROM chip or component. The electronic device 412 is programmable to store the identification data, such as a part number, a program name, a slot ID number, and the like. The electronic device 412 may be a surface mount component, such as having solder tails, solder pads, solder balls, or other conductors or leads for connection to another component, such as a circuit board or directly to the identification contacts 440.

In an exemplary embodiment, the identification device 410 includes a printed circuit board 420 hosting the electronic device 412 and the identification contacts 440, and may include other components mounted to the printed circuit board 420, such as capacitors, resistors, a processor, a memory module, or another component. The electronic device 412 is mounted to the printed circuit board 420. For example, the electronic device 412 may be soldered to the printed circuit board 420. In an exemplary embodiment, the printed circuit board 420 includes circuits, such as pads, traces, vias, and the like. The circuits may define the identification contacts 440. In alternative embodiments, the identification contacts 440 may be separate contacts, such as stamped and formed contacts, terminated to the printed circuit board 420 and extending from the printed circuit board 420 for mating with the mating identification connector 82. In the illustrated embodiment, the identification contacts 440 are pads of the printed circuit board 420 arranged at a card edge 422 of the printed circuit board 420. The card edge 422 is provided at a mating end of the identification device 410 for mating with the mating identification connector 82. For example, the card edge 422 may be plugged into the card slot 84 of the mating identification connector 82.

In various embodiments, the identification device 410 includes a device shell (not shown) holding the printed circuit board 420 and the electronic device 412. The device shell surrounds the printed circuit board 420 and the electronic device 412 to protect the components. The device shell may be an overmold body overmolded over the printed circuit board 420 and the electronic device 412. The device shell may be a composite plastic material. The card edge 422 may protrude from the device shell for mating with the mating identification connector 82.

In an exemplary embodiment, the connector identification module 402 is received in the connector chamber 204 of the frame 202 of the connector holder 200. The connector identification module 402 may be stacked adjacent to the cable connector 130. In an exemplary embodiment, the connector identification module 402 includes locating features 428 for locating the connector identification module 402 in the connector chamber 204. For example, the locating features 428 may be tabs or other protrusions received in a groove formed in the frame 202, such as in the top and bottom frame members 210, 212. Other types of locating features may be used in alternative embodiments. The connector identification module 402 may be coupled to the first side frame member 214. For example, the connector identification module 402 is coupled to an interior surface of the first side frame member 214. The printed circuit board 420 and/or the device shell may be secured to the first side frame member 214, such as using latches, clips, fasteners, and the like.

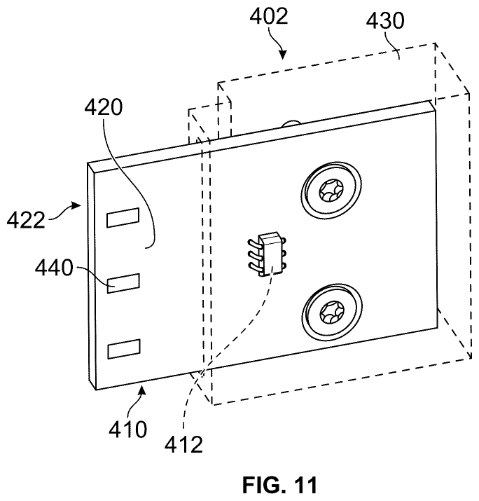

FIG. 11 is a perspective view of the connector identification module 402 in accordance with an exemplary embodiment. In an exemplary embodiment, the connector identification module 402 includes the identification device 410 and a device shell 430 holding the identification device 410.

In an exemplary embodiment, the identification device 410 includes the printed circuit board 420 hosting the electronic device 412 and the identification contacts 440, and may include other components mounted to the printed circuit board 420, such as capacitors, resistors, a processor, a memory module, or another component. The electronic device 412 stores unique identification data. The electronic device 412 may be an integrated circuit, such as a chip. In an exemplary embodiment, the electronic device 412 is an EEPROM device, such as an EEPROM chip or component. The electronic device 412 is programmable to store the identification data, such as a part number, a program name, a slot ID number, and the like. The electronic device 412 may be a surface mount component, such as having solder tails, solder pads, solder balls, or other conductors or leads for connection to another component, such as a circuit board or directly to the identification contacts 440.

The electronic device 412 is mounted to the printed circuit board 420. For example, the electronic device 412 may be soldered to the printed circuit board 420. In an exemplary embodiment, the printed circuit board 420 includes circuits, such as pads, traces, vias, and the like. The circuits may define the identification contacts 440. In alternative embodiments, the identification contacts 440 may be separate contacts, such as stamped and formed contacts, terminated to the printed circuit board 420 and extending from the printed circuit board 420 for mating with the mating identification connector 82. In the illustrated embodiment, the identification contacts 440 are pads of the printed circuit board 420 arranged at the card edge 422 of the printed circuit board 420. The card edge 422 is provided at a mating end of the identification device 410 for mating with the mating identification connector 82.

In an exemplary embodiment, the device shell 430 holds the printed circuit board 420 and the electronic device 412. The device shell 430 surrounds the printed circuit board 420 and the electronic device 412 to protect the components. The device shell 430 may be an overmold body overmolded over the printed circuit board 420 and the electronic device 412. The card edge 422 protrudes from the device shell 430 for mating with the mating identification connector 82.

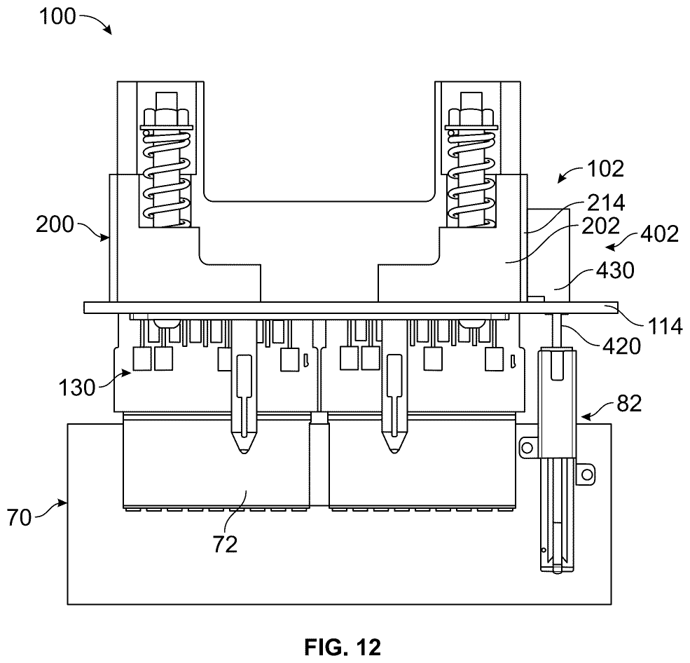

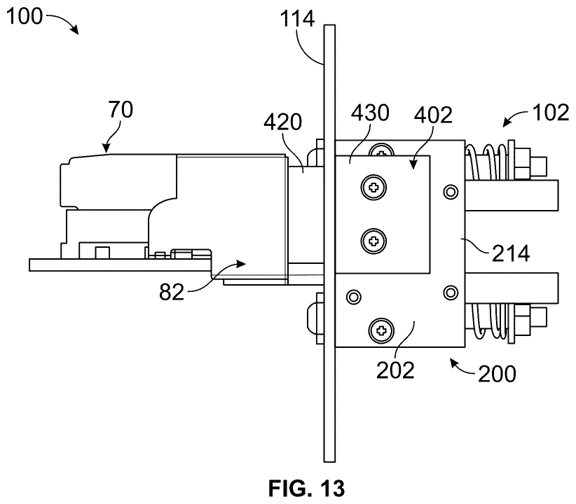

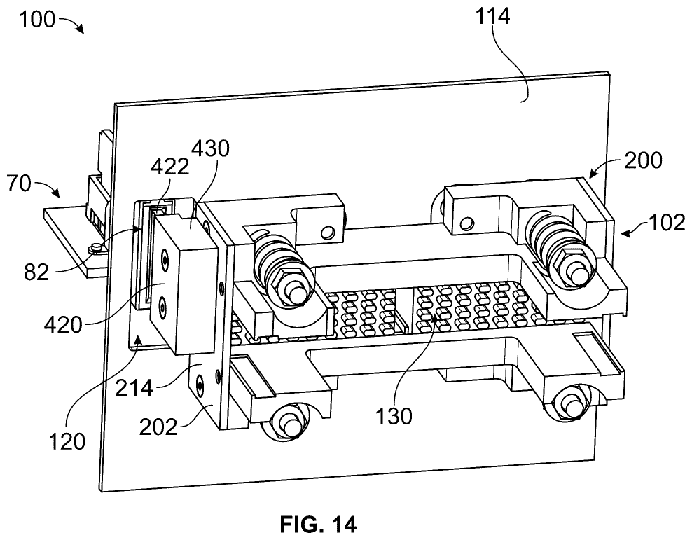

FIG. 12 is a top view of a portion of the communication system 100 in accordance with an exemplary embodiment showing the mating connector assembly 70 mated with the connector assembly 102 showing the connector identification module 402 shown in FIG. 11. FIG. 13 is a side view of a portion of the communication system 100 in accordance with an exemplary embodiment showing the mating connector assembly 70 mated with the connector assembly 102 showing the connector identification module 402 shown in FIG. 11. FIG. 14 is a rear perspective view of a portion of the communication system 100 in accordance with an exemplary embodiment showing the mating connector assembly 70 mated with the connector assembly 102 showing the connector identification module 402 shown in FIG. 11.

The cable connector 130 and the connector identification module 402 extend from the front of the connector holder 200 for mating with the mating connector assembly 70. For example, the cable connector 130 and the connector identification module 402 extend through the opening 120 in the front panel 114 for direct mating with the mating connector 72 and the mating identification connector 82.

In an exemplary embodiment, the connector identification module 402 is coupled to the frame 202 of the connector holder 200. The connector identification module 402 is arranged in line with the cable connectors 130, such as horizontally aligned with the cable connectors 130. The connector identification module 402 is coupled to the first side frame member 214. For example, the connector identification module 402 is coupled to an exterior surface of the first side frame member 214. The printed circuit board 420 and/or the device shell 430 may be secured to the first side frame member 214, such as using latches, clips, fasteners, and the like.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A connector assembly for mating with a mating connector assembly, the connector assembly comprising:
a connector holder having a frame defining a connector chamber, the frame extending between a front and a rear of the connector holder, the frame including an upper frame member, a lower frame member, and first and second side frame members extending between the upper and lower frame members to define the connector chamber, the connector holder configured to be mounted to a panel;
a cable connector received in the connector chamber, the cable connector including a connector housing holding contact assemblies, each contact assembly including a signal contact and a cable terminated to the signal contact, the signal contact configured to be mated with a mating signal contact of a mating connector of the mating connector assembly, the cable connector having a mating end extending forward from the front of the frame and configured to pass through an opening in the panel for mating with the mating connector in a mating direction; and
a connector identification module held by the frame and including a mating end configured to be mated with a mating identification module of the mating connector assembly, the connector identification module including identification contacts and an identification device, the identification contacts arranged at the mating end and configured to be mated with the mating identification module, the identification device having unique identification data stored on the identification device, the identification device being operably coupled to the identification contacts to transmit the unique identification data to the mating identification module.

2. The connector assembly of claim 1, wherein the connector identification module is coupled to the first side frame member.

3. The connector assembly of claim 1, wherein the connector identification module is aligned in plane with the cable connector.

4. The connector assembly of claim 1, wherein the connector identification module includes a printed circuit board, the identification module being mounted to the printed circuit board.

5. The connector assembly of claim 1, wherein the connector identification module includes a printed circuit board having a card edge, the identification contacts being circuits of the printed circuit board at the card edge, the card edge configured to be plugged into a card slot of the mating identification module.

6. The connector assembly of claim 1, wherein the connector identification module includes a module housing holding the identification device, the module housing being mounted to the first side frame member to position the connector identification module adjacent the cable connector to pass through the panel for mating with the mating identification module.

7. The connector assembly of claim 1, wherein the connector identification module is mounted to an exterior surface of the frame.

8. The connector assembly of claim 1, wherein the connector identification module is received in the connector chamber.

9. The connector assembly of claim 1, wherein the identification device is an EEPROM device.

10. The connector assembly of claim 1, wherein the connector identification module includes shields providing shielding for the identification contacts.

11. The connector assembly of claim 1, further comprising a mounting assembly for mounting the connector holder to the panel, the mounting assembly including a shaft, a biasing member operably coupled between the connector holder and the shaft, and a support element configured to be operably coupled between the shaft and the panel to support the shaft relative to the panel, the shaft configured to be received in a locating opening, wherein the shaft is undersized relative to the locating opening to allow a limited amount of floating movement in the locating opening in a float direction perpendicular to the mating direction to allow the connector holder and the cable connector to move relative to the panel, the biasing member forward biasing the cable connector and being compressible in a rearward compression direction parallel to the mating direction to allow the connector holder and the cable connector to move rearward relative to the panel.

12. The connector assembly of claim 1, further comprising at least one guide pin extending forward of the frame to guide mating with the mating connector.

13. A connector assembly for mating with a mating connector assembly, the connector assembly comprising:
a connector holder having a frame defining a connector chamber, the frame extending between a front and a rear of the connector holder, the frame including an upper frame member, a lower frame member, and first and second side frame members extending between the upper and lower frame members to define the connector chamber, the connector holder configured to be mounted to a panel;
a cable connector received in the connector chamber, the cable connector including a connector housing holding contact assemblies, each contact assembly including a signal contact and a cable terminated to the signal contact, the signal contact configured to be mated with a mating signal contact of a mating connector of the mating connector assembly, the cable connector having a mating end extending forward from the front of the frame and configured to pass through an opening in the panel for mating with the mating connector in a mating direction; and
a connector identification module held by the frame and including a mating end configured to be mated with a mating identification module of the mating connector assembly, the connector identification module including a printed circuit board having a card edge at the mating end, the connector identification module including identification contacts arranged at the card edge, the connector identification module including an identification device mounted to the printed circuit board, the identification device having unique identification data stored on the identification device, the identification device being operably coupled to the identification contacts, wherein the card edge is configured to be plugged into a card slot of the mating identification module when the connector assembly is mated with the mating connector assembly to transmit the unique identification data to the mating identification module.

14. The connector assembly of claim 13, wherein the connector identification module is coupled to the first side frame member and aligned in plane with the cable connector.

15. The connector assembly of claim 13, wherein the connector identification module includes a module housing holding the identification device, the module housing being mounted to the first side frame member to position the connector identification module adjacent the cable connector to pass through the panel for mating with the mating identification module.

16. The connector assembly of claim 13, wherein the connector identification module is received in the connector chamber.

17. The connector assembly of claim 13, wherein the identification device is an EEPROM device.

18. A communication system comprising:
a cartridge having panels forming a chamber, the panels including a front panel, the cartridge including ports in the front panel at a front of the cartridge;
connector assemblies received in the ports for mating with mating connector assemblies, each connector assembly including a connector holder, a cable connector held by the connector holder, and a connector identification module for identifying the cable connector within the communication system,
each connector holder having a frame defining a connector chamber, the frame extending between a front and a rear of the connector holder, the frame including an upper frame member, a lower frame member, and first and second side frame members extending between the upper and lower frame members to define the connector chamber, the connector holder being mounted to the cartridge at the corresponding port;
each cable connector received in the corresponding connector chamber, each cable connector including a connector housing holding contact assemblies, each contact assembly including a signal contact and a cable terminated to the signal contact, the cable extending from the cable connector into the chamber of the cartridge, the signal contact configured to be mated with a mating signal contact of a mating connector of the corresponding mating connector assembly, the cable connector having a mating end extending forward from the front of the frame and configured to pass through the corresponding port in the front panel for mating with the mating connector in a mating direction; and
each connector identification module held by the frame proximate to the cable connector, the connector identification module including a mating end configured to be mated with a mating identification module of the corresponding mating connector assembly, the connector identification module including identification contacts and an identification device, the identification contacts arranged at the mating end and configured to be mated with the mating identification module, the identification device having unique identification data stored on the identification device, the identification device being operably coupled to the identification contacts to transmit the unique identification data to the mating identification module.

19. The communication system of claim 18, wherein the connector identification module is coupled to the first side frame member and aligned in plane with the cable connector.

20. The communication system of claim 18, wherein the connector identification module includes a printed circuit board having a card edge, the identification contacts being circuits of the printed circuit board at the card edge, the card edge configured to be plugged into a card slot of the mating identification module.
